(19) United States
(12) Patent Application Publication
(10) Pub. No.: US 2014/0006517 A1
(43) Pub. Date: Jan. 2, 2014

(54) SYSTEM AND METHOD FOR SOCIAL INVITATIONS TO FACILITATE PLAYING AND SHARING OF MOBILE APPLICATION OR MOBILE GAME ON MOBILE DEVICE

(71) Applicants: Terry Hsiao, McLean, VA (US); Kirk Tsai, Potomac, MD (US)

(72) Inventors: Terry Hsiao, McLean, VA (US); Kirk Tsai, Potomac, MD (US)

(73) Assignee: WUPIMA, Inc.

(21) Appl. No.: 13/540,337

(22) Filed: Jul. 2, 2012

(51) Int. Cl. G06F 15/16

(52) U.S. Cl. 709/205

(57) ABSTRACT

The invention pertains to systems and method for social invitation to facilitate playing and interaction of a mobile application or mobile game on a mobile device without logging into a 3^{rd} party social networking site. A social invitation system is provided for one or more mobile devices in communication with a remote Application Growth Engine (AGE) server, via a communication network. The AGE server is provided with an AGE algorithm to create social graph associations based on address book contacts captured from an address book resident on the mobile device, and in response to a request for social invitations from the mobile device, to generate a list of recommended invitations of target users based on user social graph associations so that a user at the mobile device can invite friends, family, and colleagues from the address book to download the mobile app/game in order to facilitate playing and interaction of the mobile application or mobile game on the user's mobile device.

### FIELD OF THE INVENTION

The invention relates to a social invitation system and method for social invitations for mobile applications or mobile games and, more specifically, relates to a system and method for enhancing social invitations to facilitate playing and sharing of a mobile application or mobile game on a mobile device.

### BACKGROUND OF THE INVENTION

Mobile applications are a most rapidly developing segment of the global mobile market. These mobile applications are software designed to run on a mobile device, such as a mobile phone, personal digital assistant (PDAs), tablet computer, touchscreen tablet (e.g., Apple iTouch and Apple iPad), e-Reader, or media player, and perform certain tasks for the user of the mobile device, including, for example: (1) communications, such as email clients and mobile Web and Internet browsers; (2) multimedia, such as viewers and audio/video players; (3) productivity, such as calendars, calculators, word processors, spreadsheets and banking/finance; (4) travel such as city guides, translators, maps, schedules and weather; and (5) utilities such as address books (contact databases) or screen savers.

Many mobile applications, such as email clients, browsers and audio/video players, come pre-installed on mobile devices or side-loaded onto the mobile devices via USB cable or Bluetooth, whereas others may be available for transmission via wireless carrier networks or for download either for free or for a service fee, via application distribution platforms, typically operated by the owner of the mobile operating system (OS), such as the Apple App Store, Google Play, Amazon Appstore, BlackBerry App World, Nokia Store, and Windows Phone Marketplace. Regardless of the delivery method, mobile applications are served by an increasing number of stakeholders including mobile application users, developers (creators), publishers, mobile advertising (marketing) networks, system operators and administrators.

The most popular category of mobile applications is mobile game, which is a video game played on a mobile device. Typically, these mobile games are developed using mobile OS platforms and technologies such as Apple's iOS, Google's Android, Microsoft's Windows Mobile, RIM's BlackBerry OS, Palm's OS, Nokia's Symbian, Samsung's Bada, HP's webOS, Adobe's Flash Lite, NTT DoCoMo's DoJa, Sun's Java ME, and Qualcomm's BREW. Traditionally, most mobile game applications are focused on a single user and can be pre-installed or downloaded into the memory of the mobile device.

Recent trends in mobile games incorporate social network features from social network industries and multiplayer tools to allow players (gamers or users) to play with friends, via social networks, also known as “social games”. These social games are typically layered on top of the players' social networks and leverage the players' social graph hosted by 3^{rd} party social networking sites, such as Facebook, Twitter, etc. in order to allow the players to play or share their games with friends. Typically, 3^{rd} party social networking sites are utilized to create and store player profiles and a record of their relationships with other players in the social networks (i.e., social graph), as well as other services (e.g., wall-posts, photo-sharing) to facilitate social interaction between players playing such “social games”. As such, players can interact and track other players, including the latest statuses and updates of other members within their “social graph” provided by (and maintained at) these 3^{rd} party social networking sites. Likewise, new social players or allies can also be recruited and invited to play such games, via the social networks.

However, these players must “log in” (sign in) with 3^{rd} party social networking sites, such as Facebook and Twitter, in order to access protected user data on those sites for social network features. Moreover, social network connections, such as Facebook Connect, can only produce a connection “an association” if both players log in to the 3^{rd} party social network site from the mobile application or mobile game. Without such “log in”, these 3^{rd} social networking sites cannot provide user's social profile, connections (associations) or any information on the mobile device of the user or the user's connections. Furthermore, the “social graph”, which describes the relationships between available Internet users, is owned by the 3^{rd} party social network site and is not shared with other services. Even with 3^{rd} party social networking sites, most players still find it hard to find friends to play the games because there is no easy way of knowing which friends have the same games on their mobile devices.

Currently social invitations are limited to email or through social networks, both of which are less actionable and less effective than methods described herewith by the System for Social Invitations. The reasons are that the person receiving the invitation, either through email or a message from a social network, such as Facebook, may or may not be reading this particular invitation on a mobile device, and that the URL link that is included within the invitation does not directly lead to the actual installation (download) of the mobile application or mobile game.

Accordingly, two elements are needed which will significantly improve the process of social invitations. First is the need to send the invitation directly to the mobile device, and the only sure way to accomplish such requirement is to deliver the invitation via SMS sent to the phone number of the target mobile device. Secondly, there is a need to “pre-qualify” such social invitations, that only players with a supported mobile device, running on a supported network carrier infrastructure and mobile device operating system (OS) shall receive relevant invitations. These steps are important in order to improve overall user experience and produce accurate calculations for effectiveness of these social invitations; otherwise, social invitations to those players who cannot download or play the mobile game, based on mobile device, network carrier or operating system (OS) limitations, are not very useful. Likewise, there is a need for mobile app and game developers and publishers to promote and better engage existing players in a more vibrant gaming network as well as to analyze, target and acquire new users or players.

### SUMMARY OF THE INVENTION

Accordingly, it is therefore an object of the present invention to provide social invitation methods and tools to allow a user's mobile device to invite contacts to download a mobile application or mobile game in order to facilitate playing and sharing of the mobile application or mobile game on the mobile device.

It is also an object of the present invention to provide tools that can be embedded or integrated into a mobile application or mobile game at a mobile device to allow a user to capture a mobile contact list (“address book”) resident on the mobile device, such contacts sorted and filtered based on information provided by the developer or publisher of the mobile application or mobile game, and then invite or send personalized invitations (via custom text messages) to friends, family, and colleagues, for the purpose of downloading a mobile application or mobile game in order to facilitate playing and sharing of the mobile application or mobile game on the mobile device, without logging into a 3^{rd} party social networking site and to maximize the chance of referral success.

It is further an object of the present invention to provide an Application Growth Engine (AGE) module in a form of a software development kit (SDK) that can be downloaded directly via the Internet or plugged-in (added-on) a mobile application or mobile game at a mobile device to enable current users to invite and play with friends, family, and colleagues from their mobile contact lists without ever logging into a 3^{rd} party social networking site, and to also enable mobile application and game developers (1) to increase engagement among current users, (2) to access the connections of these current users and to promote their mobile application or mobile game in their users' personal networks, and (3) to analyze, target and acquire new users and grow market share, via social invitations, in order to reduce or optimize new user acquisition costs for developers and publishers of mobile application or mobile game.

It is also an object of the present invention to provide an Application Growth Engine (AGE) software development kit (SDK) that can be downloaded directly via the Internet or plugged-in (added-on) a mobile application or mobile game at a mobile device to enable a user to share single or multi-player games and show the user what other players (contacts in his/her mobile device) have the same game installed, who can play now and who can be invited to download the game and play from the user's mobile contact list (address book) by cross-referencing information used to sort and filter the list to maximize the likelihood of successful (accepted) social invitations. Some example of such information is the target user's (individual receiving the invitation) network carrier, mobile device make and model, device operating system (OS), etc.

It is another object of the present invention to provide an App Growth Engine (AGE) web-enabled real-time dashboard to allow mobile application and game developers to learn about users' contact list connections, to track invitations, to view invitation reports by operating systems, mobile device make and model, network carriers, and to analyze new user conversion rates, social user trends across platforms, mobile devices, operating system (OS), and network carriers.

To achieve these and other objects in accordance with one aspect of the present invention, an AGE social invitation system is provided with one or more mobile devices in communication with a remote AGE server, via a communication network. The mobile device is provided an AGE enabled mobile app/game to allow a user to capture address book contacts from an address book resident on the mobile device and then invite friends, family, and colleagues from the address book for the purpose of downloading the mobile application or mobile game in order to facilitate playing and sharing of the mobile application or mobile game on the mobile device without logging (“signing-in”) into a 3^{rd} party social networking site. The remote AGE server is provided with an AGE algorithm to create social graph associations based on address book contacts captured from an address book resident on the mobile device, and in response to a request for social invitations from the mobile device, to generate a list of recommended invitations of target users based on user social graph associations in order to facilitate sharing of the application or game on the user's mobile device.

In accordance with an aspect of the present invention, a mobile device for sending and receiving social invitations to facilitate sharing of a mobile application or mobile game is provided with a communication interface arranged to connect the mobile device to a communication network; a memory to store the mobile application or mobile game; and a processor system, when the mobile application or mobile game is launched or when a predetermined event is triggered, configured to transmit address book contacts, from an address book resident on the mobile device, to a remote AGE server, via the communication network, for user social graph associations; send a request for social invitations to the remote AGE server, via the communication network; receive, from the remote AGE server, a list of recommended invitations of target users based on the user social graph associations for a visual display on the mobile device; and send recommended invitations to the target users to facilitate sharing of the mobile application or mobile game on the mobile device.

In accordance with another aspect of the present invention, a remote AGE server for sending and receiving social invitations to facilitate sharing of a mobile application or mobile game is provided with a communication interface arranged to connect the AGE server to a communication network; and a processor system configured to create social graph associations based on address book contacts captured from an address book resident on the mobile device, and in response to a request for social invitations from the mobile device, generate a list of recommended invitations of target users based on user social graph associations and transmit the list of recommended invitations to the mobile device, for social invitations to the target users to facilitate sharing of the mobile application or mobile game on the mobile device.

In accordance with various implementations of the present invention, the request for social invitations can be sent to one or more target users identified from the address book contacts having the same mobile application or mobile game installed in their mobile devices for playing and sharing on the mobile device. The recommended invitations can be sent directly from the mobile device, via a short messaging service (SMS), or alternatively, from the remote AGE server, via a short messaging service (SMS), based on a request from the mobile device. The list of recommended invitations are optimized based on specific inputs, including: (1) user social graph associations; (2) a user profile and system activity profile gathered from multiple mobile applications or mobile games; (3) pre-qualification of social invitations to targeted users based on the user's mobile device make and model, mobile carrier, and mobile operating system; and (4) relevant behavioral data tracking effectiveness of each social invitation.

The present invention is more specifically described in the following paragraphs by reference to the drawings attached only by way of example.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 illustrates an example social invitation system including one or more mobile devices having an Application Growth Engine (AGE) enabled application in communication with an AGE server, via a communication network, according to an example embodiment of the invention;

FIG. 2 illustrates a mobile device according to an example embodiment of the invention;

FIG. 3 illustrates an AGE server according to an example embodiment of the invention;

FIG. 4 illustrates a mobile application registration process between an application developer and an AGE server according to an example embodiment of the invention;

FIG. 5A illustrates a mobile originated (MO) verification sequence diagram originated from a mobile device to an AGE server according to an example embodiment of the invention;

FIG. 5B illustrates a mobile terminated (MT) verification sequence diagram originated from an AGE server to a mobile device according to another embodiment of the invention;

FIG. 6 illustrates an AGE address book discovery sequence diagram between a mobile device and an AGE server according to an example embodiment of the invention;

FIG. 7 illustrates an address book discovery flowchart performed by an AGE server according to an example embodiment of the invention;

FIG. 8A illustrates an AGE social invitation sequence diagram without an app query between a mobile device and an AGE server according to an example embodiment of the invention;

FIG. 8B illustrates an AGE social invitation sequence diagram with an app query between a mobile device and an AGE server according to an example embodiment of the invention;

FIG. 9 illustrates an example social invitation delivery and tracking sequence between a mobile device and an AGE server for a single invitee according to an example embodiment of the invention;

FIG. 10 illustrates an example social invitation delivery and tracking sequence between a mobile device and an AGE server for multiple invitees according to an example embodiment of the invention;

FIGS. 11A-11C show a currently available mobile game and known process of creating an account either by providing an email log-in or Facebook log-in credentials; and

FIGS. 12A-12C show a currently available mobile game and known process of initiating a game play, via Game ID username, email, random or Facebook.

### DETAILED DESCRIPTION OF THE INVENTION

The present invention is applicable for use with all types of communication networks, mobile platforms, and mobile applications including mobile games running on mobile devices, via a communication network. However, for the sake of simplicity, discussions will concentrate mainly on a mobile application running on a mobile device in communication with a remote server, via a communication network, although the scope of the present invention is not limited thereto.

In accordance with the present invention, components, process steps, functions, routines, data structures and/or modules may be implemented in software or hardware, such as, for example, a field programmable gate array (FPGA) and an application specific integrated circuit (ASIC) for use with known mobile operating system (OS) platforms and technologies, such as Apple's iOS, Google's Android, Microsoft's Windows Mobile, RIM's BlackBerry OS, Palm's OS, Nokia's Symbian, Samsung's Bada, HP's webOS, Adobe's Flash Lite, NTT DoCoMo's DoJa, Sun's Java ME, and Qualcomm's BREW. The mobile devices may be implemented using mobile phones, personal digital assistants (PDAs), tablet computers, touchscreen tablets (e.g., Apple iTouch and Apple iPad), e-Readers, media players, and/or other handheld computing devices that have an operating system (OS) and can run various types of application software. As used herein, the term “mobile games” refers to downloadable games that reside on a mobile device, which is a portable communication device that has access to a mobile communication network. Examples of mobile devices include, but not limited to, smart phones (e.g., mobile phones built on a mobile computing platform such as Apple iPhones), personal digital assistants (PDAs), tablet computers, touchscreen tablets (e.g., Apple iTouch and Apple iPad), e-Readers, media players, and/or other handheld devices.

In accordance with various embodiments of the present invention, social invitation tools include (1) an AGE module integrated into a mobile application or game at a mobile device, i.e., an AGE enabled application designed to capture contacts or “contact list” (or commonly known as “address book”) resident on the mobile device, to request for social invitations and send recommended invitations to friends, family and colleagues for playing and sharing of the mobile application/game; and/or (2) a library of AGE components that reside at a remote AGE server, via a communication network, to provide a broad range of value-added AGE services and functions, including verifying the phone number of the user's mobile device, and gathering a set of available data from the user's mobile device, i.e., address book contacts from the user's mobile device, to create “social graph” associations in order to optimize the use of social invitations and accelerate and strengthen user adoption, conversion and consumption of mobile applications, while also generating user and usage intelligence critical to the application developers and end users. The social invitations can be optimized based on specific inputs, including, for example: (1) user “social graph” associations; (2) system activity profile gathered from multiple applications or games; (3) pre-qualification of social invitations to targeted users based on the user mobile device, mobile carrier, and mobile operating system (OS); and (4) relevant behavioral data tracking effectiveness of each social invitation. Once the user triggers the delivery of social invitations, SMS (short message service) message can be delivered to the target user's mobile device, via the communication network. The SMS message may include an invitation to download an application and an URL (uniform resource locator) link where the application or game can be downloaded. This way the social invitations are “actionable”, meaning the target user is able to click on the URL provided in the invitation to download the mobile application or mobile game right from the target user's mobile device.

In various implementations of the invention, the AGE module is a Software-as-a-Service (SaaS) for mobile application developers and providers, also known as “on-demand software” in which software and associated data can be hosted on the remote AGE server and accessed by the mobile application and game developers, via a web browser. In particular, the AGE module is a network-based application programming interface (API) service made available to mobile application developers and providers through a standard software development kit (SDK). However, the API client (i.e., mobile device) is not limited by programming language, mobile operating system (OS) or hardware platform. As such, as long as an API client is able to communicate via communication protocols used for the Internet and similar networks, such as TCP/IP (Transmission Control Protocol (TCP) and Internet Protocol (IP)), the AGE module can be accessed, downloaded directly via the Internet or plugged-in (added-on) a mobile application or mobile game at a mobile device, via a communication network.

As such, the social invitation tools support different views from each stakeholder's perspective in the overall ecosystem, including: (1) users, (2) mobile application and game developers, (3) application and game publishers, and (4) system operator or administrator. These views represent different value propositions and each provides a bi-directional feed to improve the overall performance of social invitations. For example:
(1) Users care about how many and what invitations they have sent to, and/or have received from their associations. In addition, the users also care about which games and with which contacts/associates they can play with. Each user could be interested to find contacts to play a particular game, accept an invitation to play a game with a friend, or initiate game play by inviting others. With information collected and analyzed by the AGE server, the users are provided valuable information to aid their ease of finding a match in game play, ease of inviting the right associations to play with (supported mobile devices and networks, matching user activity profiles, etc.);
(2) Developers care about which platforms they should focus development resources on. For example, users are 60% on Apple's iOS, 25% on Google's Android, 10% on Microsoft's Windows Mobile and 5% on RIM's BlackBerry, the developer might decide whether or when to develop applications or games for Windows Mobile or/and Blackberry;
(3) Publishers care about how to acquire new users and optimize the cost for acquiring these users. The AGE server provides information on effective conversion rates of using “social invitations” as compared to other channels of user acquisition. Users who have in fact sent or accepted invitations would be valued higher than others, for example. The data and information provided by the AGE server also helps the application and game publishers to spend more resources in acquiring users in a particular mobile platform (such as Apple's iOS) vs. other mobile platforms (such as Google's Android, Microsoft's Windows Mobile or RIM's BlackBerry); and
(4) System operators or administrators care about the overall performance and effectiveness of all input and output processing and activities. The AGE server also monitors each game specific performance metrics and manages user requested actions.

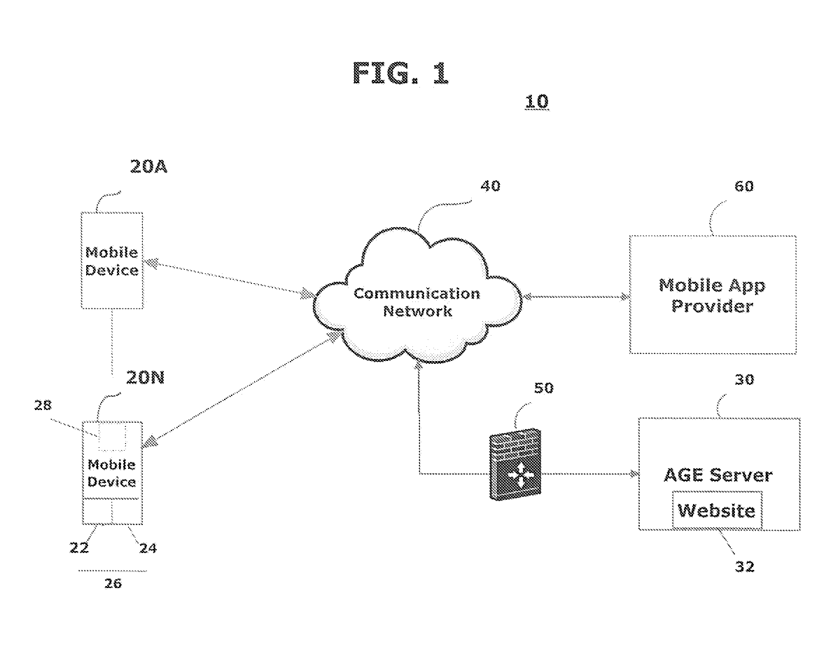

Turning now to the drawings and particularly to FIG. 1, an AGE social invitation system according to an example embodiment of the invention is illustrated. As shown in FIG. 1, the AGE social invitation system 10 comprises one or more mobile devices 20A-20N in communication with a remote AGE server 30, via a communication network 40 and, optionally, a firewall 50.

Each mobile device 20 is provided with an operating system (OS) and one or more mobile applications including at least one mobile application (or mobile game) 22 having an AGE module 24 embedded or integrated therein, referred herein as an AGE enabled mobile application 26. The AGE module 24 can be in a form of a software development kit (SDK) that can be downloaded directly, via the Internet from the remote AGE server 30, or alternatively, can also be plugged-in (added-on) with an interface (UI) to the mobile application (or mobile game) 22 at the mobile device 20 by the application developer. Alternatively, the AGE enabled mobile application 26 can be made available at a mobile application provider 60 such as Apple App Store, Google Play, Amazon Appstore, BlackBerry App World, Nokia Store, and Windows Phone Marketplace, for download.

Once integrated into the mobile application 22 by the developer and/or made available by the mobile application provider 60, the AGE enabled mobile application 26 at the user's mobile device 20 advantageously allows the user to capture a mobile contact list (“address book”) resident on the user's mobile device 20 and then invite or send personal invitations (custom text messages) to friends, family, and colleagues from the address book to download the user's mobile application or mobile game in order to facilitate playing and sharing of the mobile application or mobile game on the mobile device 20 without logging into a 3^{rd} party social networking site, such as Facebook or Twitter, and to maximize the chance of referral success.

Each mobile device 20 may also have a web browser 28 (e.g., Microsoft Windows, Internet Explorer, Mozilla Firefox, Apple Safari, Google Chrome, and Opera, etc.), to access and view content, via the communication network 40, and may have one or more add-ons, plug-ins, or other extensions, such as Toolbar and Yahoo Toolbar.

The AGE server 30 is provided with a library of AGE components to provide a broad range of value-added AGE services and functions, including, for example: (1) verifying the phone number of the user's mobile device for “social graph” associations upon a request initiated from either the AGE enabled mobile application 26 at the mobile device 20 or the AGE server 30; (2) creating “social graph” associations of a particular user based on the user's address book contacts, a user profile and application attributes (e.g., pre-qualification of social invitations to targeted users based on the user mobile device, mobile operating system and mobile carrier) to optimize the use of social invitations for the user's mobile device 20 in order to enable mobile application and game developers (1) to increase engagement among current users, (2) to leverage existing users and their contacts information to promote their mobile application or game 22 in their users' personal networks. In addition, the AGE server 30 may also be configured (1) to track invitations or system activity profile gathered from multiple applications or games and (2) to gather user behavioral data to determine the effectiveness of each social invitation in order to enable mobile application and game developers to analyze, target and acquire new users and grow market share, via social invitations, and to reduce new user acquisition costs from dollars to pennies per user for mobile developers and game publishers.

The communication network 40 provides network capabilities for a plurality of mobile devices 20A-20N and enables mobile device users to engage with one or more mobile applications/games or to participate in single player or multiplayer games. It should be appreciated, however, that the present invention is not limited to any specific type of communication network or access technology. For example, the communication network 40 may be implemented using a mobile communication network having one or more base stations (BSs) or wireless access points (APs) for communicating with mobile devices 20A-20N and/or a data communication network including a private wireless and/or a wire-line network. Examples of such mobile communication technologies include, but not limited to, Global System for Mobile Communication (GSM), General Packet Radio Service (GPRS), Code Division Multiple Access (CDMA), Evolution-Data Optimized (EV-DO), Enhanced Data Rates for GSM Evolution (EDGE), 3GSM, WCDMA, and Long Term Evolution (LTE), WiFi (802.11x) and WiMax (802.16x). Mobile communication network may also connect to a Package Data Network (PDN) or a packet-switched network that utilizes conventional communication protocols, such as the suite of Internet Protocols, also known as TCP/IP. The PDN may comprise a public or public network, and may be a local area network (LAN) or a wide area network (WAN). The Internet is one well-known example of a PDN. However, these are examples only and one of ordinary skill will understand that other types of communication techniques are within the scope of the present invention. Further, it will be understood that additional components may be used in the communication of information between the users of mobile devices and the AGE server. Such additional components may include, but not limited to, lines, trunks, antennas, switches, cables, transmitters, receivers, computers, routers, servers, fiber optical transmission equipment, repeaters, amplifiers, etc.

The mobile devices 20A-20N may communicate with the AGE server 30 using conventional Web Application Programming Interface (API) based on Hypertext Transfer Protocol (HTTP). HTTP is a request-response protocol within the framework of the Internet Protocol Suite to enable communications between mobile devices 20A-20N (“clients”) and AGE server 30 (“servers”) in the client-server computing model. For example, during an HTTP session, a mobile device 20 may submit an HTTP request message to the AGE server 30. The AGE server 30, which provides HTTP resources such as HTML files and other content, or which performs other functions on behalf of the mobile device 20, returns a response message to the mobile device 20. The HTTP response contains completion status information about the HTTP request and may also contain requested content in its message. For example, when a user at the mobile device 2 enters a Uniform Resource Locator (URL) or other address directing the web browser 28 installed at the mobile device 20 to the AGE server 30, via the communication network 40, and the web browser 28 may generate a HTTP request and communicate the HTTP request to the AGE server 30. The AGE server 30 may accept the HTTP request and communicate to the mobile device 20 one or more Hyper Text Markup Language (HTML) files responsive to the HTTP request. Mobile device 20 may render a web page based on the HTML files from AGE server 20 for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

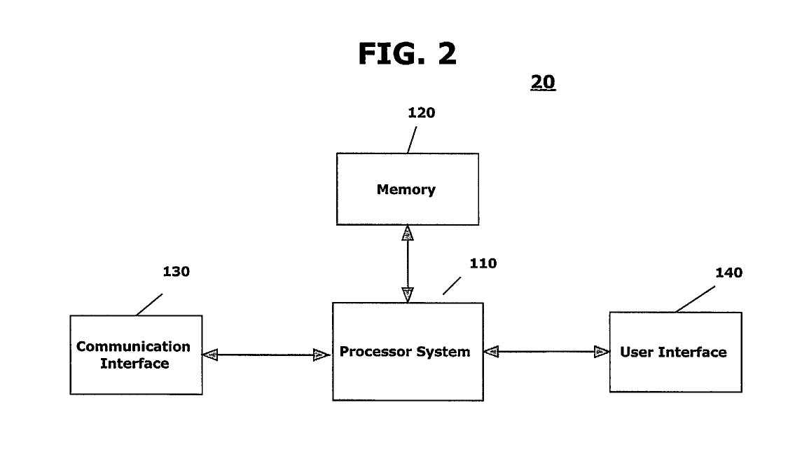

FIG. 2 illustrates an example mobile device according to an example embodiment of the invention. As shown in FIG. 2, the mobile device 20 comprises a processor system 110, a memory 120, a communication interface 130, and a user interface 140. The processor system 110 may comprise one or more microprocessors, microcontrollers, hardware circuits, and/or a combination thereof, for executing mobile applications or games and for communicating with the AGE server 30. Memory 120 stores data and programs, such as, mobile operating system (OS) needed by the processor system 110, and one or more mobile applications including at least one mobile application or game 22 having an AGE module 24 integrated therein (i.e., AGE enabled mobile application 26, shown in FIG. 1). Memory 120 may comprise one or more discrete memory devices, such as random access memory, read-only memory, and flash memory. Communications interface 130 connects the mobile device 20 to the communication network 40. The communication interface 130 may comprise, for example, a cellular transceiver, WiFi transceiver, an Ethernet interface, cable modem, or DSL interface. The user interface 140 may comprise a display for viewing game information and one or more input devices, such a keypad, joystick, etc., for receiving user input. The mobile device 20 may further include a GPS receiver (not shown) for determining the location of the mobile device 20. As previously discussed, the AGE enabled mobile application advantageously allows the user to capture a mobile contact list (“address book”) resident on the user's mobile device 20, and then invite or send social invitations (custom text messages) to friends, family, and colleagues from the address book who have the same application or game installed in their mobile devices, or friends who are likely to play, to download the user's mobile application or mobile game in order to facilitate playing and sharing of the mobile application or mobile game on the mobile device 20 without logging into a 3^{rd} party social networking site, such as Facebook or Twitter.

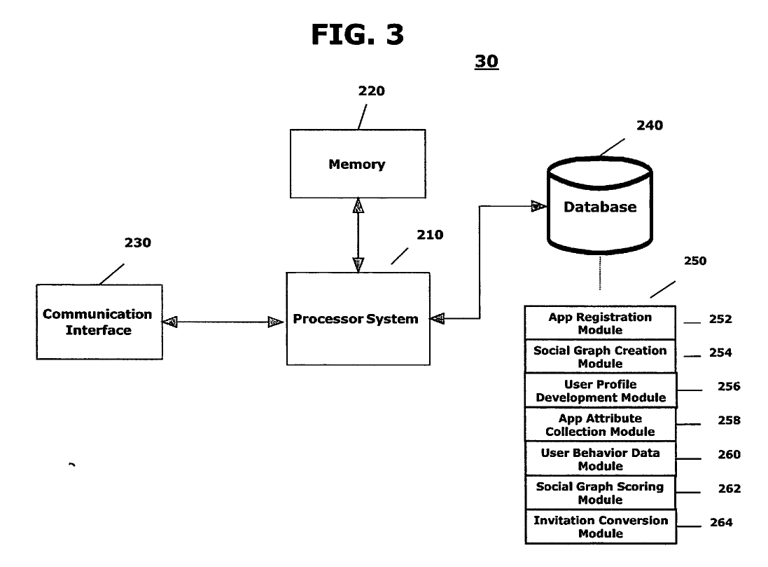

FIG. 3 illustrates an AGE server according to an example embodiment of the invention. As shown in FIG. 3, the AGE server 30 comprises a processor system 210, memory 220, communication interface 230, and a mass storage device 240. The data processor system 210 may comprise one or more microprocessors, microcontrollers, hardware circuits, and/or a combination thereof. Memory 220 stores data and programs, such as operating system (OS) needed by the processor system 210. Memory 220 may comprise one or more discrete memory devices, such as random access memory, read-only memory, and flash memory. Communications interface 230 connects the AGE server 30 to the communication network 40. The communication interface 230 may comprise, for example, an Ethernet interface, cable modem, or DSL interface. The AGE server 30 receives HTTP requests and sends HTTP responses to players at mobile devices 20A-20N, via the communication interface 230.

The mass storage device (database) 240 contains a library of AGE components 250 that provide AGE services to independent programs, via an API, and that, although separate, work together to perform sets of functions which form a complete, end-to-end process or delivery lifecycle of social invitations in order to enhance the usefulness and effectiveness of the social invitations for end users and mobile application or mobile game developers. The AGE components 250 are configured to create social graph associations based on address book contacts captured from an address book resident on the user's mobile device 20, and to calculate a (relevant and desired) set of target users from each user's social graph associations for social invitations, based on a set of available data from the user's mobile device 20.

In accordance with an example embodiment of the present invention, the AGE components 250 may include: (1) an application registration module 252 to enable one or more application developers to establish an account and create an application profile for each mobile application or game with the AGE server 30, via a website 32, and to enable app users to register their mobile phone numbers assigned to the mobile devices 20A-20N with the AGE server 30; (2) a social graph creation module 254 to create the user's social graph associations, or relational connections between the users; (3) a user profile development module 256 to develop each user profile and optimize “social invitations” based on the user activity profile and the contact's preferences; (4) an application attribute collection module 258 to collect mobile application attributes and characteristics, including an application profile provided by the application developer during the initial registration; (5) a user behavior data module 260 to collect historical data of past invitations and further add user behavioral analytics to the mobile user's social graph to calculate the effectiveness of social invitations; (6) a social graph score module 262 to assign a social score for each contact from the mobile user's address book and generate a list of optimal social invitations to targeted invitees for application sharing based on the user's social graph associations and other inputs that overlay on the social graph associations, including the mobile application attributes and the user behavioral analytics; and (7) an invitation conversion module 264 to track each invitation sent, including all referrals or friends who install the same app/game in order to determine conversion rates for each application invitation and for use in future invitations. However, AGE components 250, as shown in FIG. 3, can be embedded or integrated into a single AGE algorithm, or alternatively, can be implemented in firmware or hardware, such as, for example, a field programmable gate array (FPGA) and an application specific integrated circuit (ASIC).

Application Registration Module 252

In order to access AGE service for mobile applications or games, a mobile application or game developer (customer) must first establish an account with the application registration module 252 at the AGE server 30, via the AGE developer website 32, located, for example, at http://www.hookmobile.com. Tutorials and guides are available for mobile app and game developers to download the AGE module 24 in a form of a software development kit (SDK) directly, via the AGE developer website 33 on the AGE server 30, shown in FIG. 1, to implement AGE with mobile application in different mobile platforms, for example, AGE for iOS or AGE for Android, including registration of mobile application with AGE server 30, mobile device verification, address book capture, request for social invitations or friends with the same app/game, send social invitations, and track invitations for conversion rates.

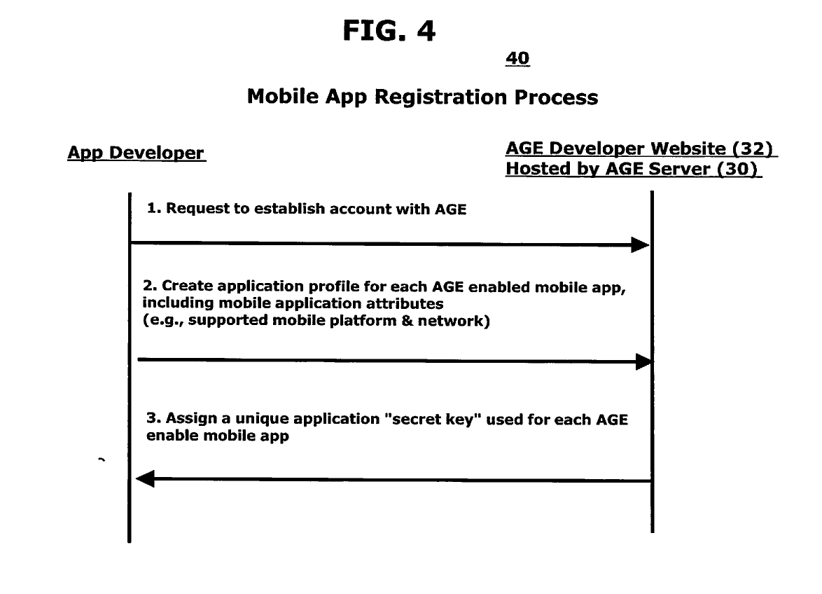

An example mobile application registration process between an app developer and an AGE server 30 is shown in FIG. 4. Referring now to FIG. 4, the following steps outline the registration process for customer account and mobile application. First, an app developer must access the AGE developer website 33 on the AGE server 30, via the Internet, and request to establish a developer account with the application registration module 252 at the AGE server 30 before a host mobile application can be provisioned to communicate with the AGE server 30.

Under each account, the developer (customer) may register one or more mobile applications that use the AGE service. Second, the developer (customer) then creates an application profile for each mobile application 22 that uses AGE service. In each application profile, the developer (customer) can define a set of qualification criteria/filters, for example, application attributes including, but not limited to:
i. An application type (game, utility, etc.);
ii. Supported mobile platforms such as mobile device and operating system (OS) compatibility for the mobile application (e.g., iOS, Android, Windows Mobile, and BlackBerry RIM); and
iii. Wireless network parameters (e.g., AT&T, Verizon Wireless, T-Mobile, and Sprint).

In addition, the developer (customer) may also define a list of keywords associated with the mobile application. These keywords may correlate to the nature, purpose, category or description of the mobile application or game, and may be used not for filtration but for ranking qualified contacts' relevance to the target applications. These criteria/filters are the first inputs into the application registration module 252 at the AGE server 30, which will be used to build the social graph associations and applied to the list of contacts from the address book to qualify contacts that meet the carrier network and mobile platform/OS requirements for the target mobile application. Third, a unique application “secret code” (i.e., “appKey”) is then assigned to a specific application profile under a developer account. The unique application “secret code” (i.e., “appKey”) is incorporated into a mobile application (or mobile game) 22 along with the AGE module 24, and will be used for authentication purpose every time an API call is issued from the host mobile application 22 installed at a mobile device 20 against the AGE server 30.

In addition to the developer registration process, the mobile user must also register the user's mobile number assigned to the mobile device 20 with the application registration module 252 at the AGE server 30. This can be accomplished by accessing the mobile number directly from a mobile device API or by embedding an SMS (short messaging service) to be sent from the mobile device to an AGE managed 10-digit phone number (as per the international public telecommunication numbering plan, E.164 format, used in the PSTN and other data networks) hosted by the AGE server 30.

For example, when an AGE enabled mobile application or game (i.e., a mobile application having an AGE module integrated therein) is launched by a user for the 1^{st} time, an SMS message is automatically created and could be sent from the mobile device 20 to the AGE server 30, via the communication network 40, to register the mobile number with the AGE platform. The mobile number will assist the mobile application in facilitating social interaction with other mobile devices having the same mobile application. Once the developer (customer) has completed registration, the AGE enabled mobile application 26 can start using AGE service, via AGE Web API based on HTTPs.

Social Graph Creation Module 254

The creation of the user's “social graph” is the foundation of the social graph creation module 254 at the AGE server 30, shown in FIG. 3, and is the basis by which to determine the value or “score” of targeted contacts for prioritization and social invitations. The “social graph” consists of a number of data assets gathered and created, including, for example: (1) Mobile Phone Number Verification (2) Address Book Capture, (3) Address Book Associations Graphed and (4) Address Book Contacts Analysis. The key elements of the social graph creation module 254 at the AGE server 30 are described in detail herein below:

(1) Mobile Phone Number Verification:

The key to the effectiveness of the AGE server 30 is to accurately identify the mobile device owner by phone number. The phone number of the mobile device is the main building block of the social graph creation. Phone number verification process works similarly to email verification in website signup/verification. However, there are two different (mutually exclusive) ways in which an app developer can program or set the AGE enabled mobile application 26 to verify the phone number of the mobile device 20, including: (1) Mobile Originated (MO) Verification, or (2) Mobile Terminated (MT) Verification. For Mobile Originated (MO) Verification, a mobile originated (MO) SMS can be pre-populated with content and phone number of the mobile device addressed to the AGE managed 10-digit phone number (virtual number), and sent from the mobile device 20 to the AGE server 30. The user can then be asked to click on “SEND” to complete the verification. In contrast, for Mobile Terminated (MT) Verification, a mobile terminated (MT) SMS can be populated with instructions and a verification link, and sent from the AGE server 30 to the mobile device 20. The user can then be asked to click on the verification link, and upon click through, can be redirected to an app URL scheme for the app.

In general, MO Verification provides the better user experience because the user is not required to enter the phone number of the mobile device 20. However, MO Verification is designed to work mainly with a specific mobile platform such as Apple's iOS or another operating system (OS) where a native SMS composer app can be launched within a mobile application or mobile game. In contrast, MT Verification requires the user to provide a phone number where the MT Verification SMS is to be addressed. However, the key benefit of using MT SMS is saving message cost for user, especially for apps designed for an international audience (outside U.S.).

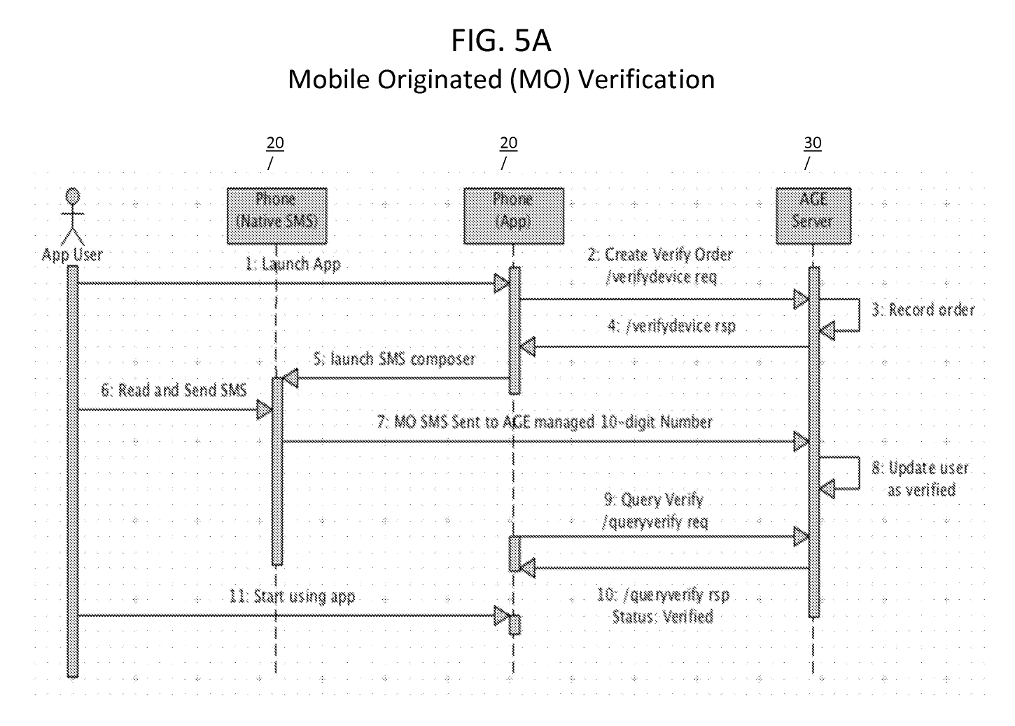

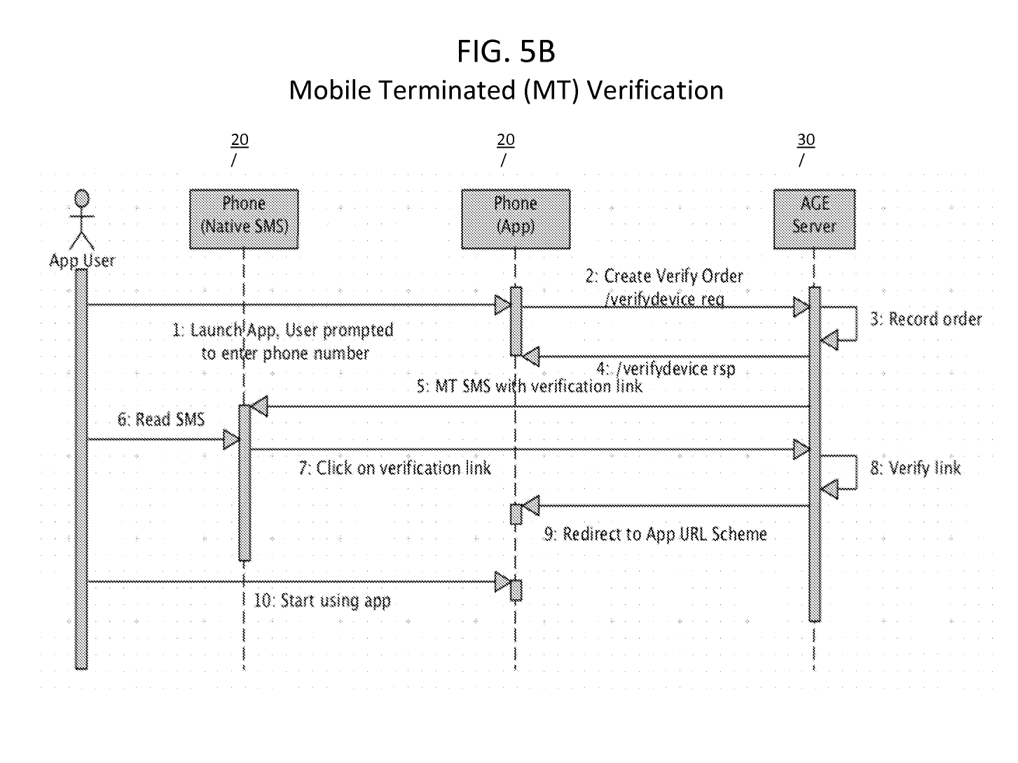

Turning now to FIGS. 5A-5B, example sequence diagrams that illustrate MO Verification and MT Verification call flow between a mobile device 20 and an AGE server 30 are illustrated. In particular, FIG. 5A illustrates a Mobile Originated (MO) Verification sequence diagram originated from an AGE server 30 to a mobile device 20 according to an embodiment of the invention. As shown in FIG. 5A, when a host application 22 is launched by the user's mobile device 20 for the 1^{st} time, for example, at step #1, the host application 22 may call the AGE module 24 at the mobile device 20 for a mobile phone number verification function. If the phone number of the mobile device 20 has been verified, the user may interface with the host application 22 and proceed with other functions. However, if the phone number of the mobile device 20 has not been verified, the host application 22 may invoke an API call for phone number verification containing the application ID (“appKey” assigned to the application in use) and create a phone number verify order (/verifydevice) to request a unique ID (“installCode” or verification code assigned to each app install by AGE server 30) from the AGE server 30 at step #2. Alternatively, the host application 22 may create a phone number verify order to request a unique ID from the AGE server 30 based on an occurrence of certain event(s) set by an application developer.

Upon receipt of such a “verify device” request, the AGE server 30 records the transaction in the database 240, shown in FIG. 3, at step #3. All AGE transactions can be recorded in the database 240 using a particular time zone, such as GMT (Greenwich Mean Time) time zone or UTC (Coordinated Universal Time) time zone, including date and a timestamp in any readable format. The AGE server 30 then generates a “verify device” response with a unique ID (“installCode” or verification code) to uniquely identify the verification transaction at step #4. A native SMS composer application is launched at the mobile device 20 at step #5 in order to compose a MO SMS message to be sent to an AGE managed 10-digit phone number and routed to the AGE server 30, via the communication network 40. The SMS message contains an originating phone number of the mobile device 20, an AGE managed 10-digit phone number addressed to the AGE server 30 and a specific text with reference to the verification code.

For example, if the phone number of the mobile device is (301) 234-5598, the AGE managed 10-digit phone number (virtual number) is (302) 517-5040, and the verification code is “8emA5gCW”, the SMS message can be represented as follows:

From: (301) 234-5598
To: (302) 517-5040
Please send this SMS to confirm
your mobile device (8emA5gCW)

Upon receipt of the SMS message, the AGE server 30 (by way of the social graph creation module 254, shown in FIG. 3) parses the SMS to extract and validate the phone number of the mobile device 20 and the unique ID (“installCode” or verification code) and updates the transaction in the database 240 as verified at step #8. Next, the host application 22 may query verification status (/queryverify) to check with the AGE server 30 if the user has completed the phone number verification at step #9 and step #10. MO Verification is completed when the AGE server 30 receives the SMS message from the user having the correct verification code.

In contrast to FIG. 5A, FIG. 5B illustrates a Mobile Terminated (MT) Verification sequence diagram originated from an AGE server 30 to a mobile device 20 according to another embodiment of the invention. As shown in FIG. 5B, when a host application 22 is launched by the user's mobile device 20 for the 1^{st} time, for example, at step #1, the host application 22 may call the AGE module 24 at the mobile device 20 for a mobile phone number verification function. If the phone number of the mobile device 20 has been verified, the user may interface with the host application 22 and proceed with other functions. However, if the phone number of the mobile device 20 has not been verified, the user is prompted to enter a phone number of the mobile device 20 to complete the verification. The host application 22 then invokes an API call for phone number verification containing the phone number of the mobile device 20 and the application ID (“appKey” assigned to the application in use) and creates a phone number verify order (/verifydevice) to request a unique ID (“installCode” or verification code assigned to each app install by AGE server 30) from the AGE server 30 at step #2.

Upon receipt of such a “verify device” request, the AGE server 30 (by way of the social graph creation module 254, shown in FIG. 3) records the transaction in the database 240, shown in FIG. 3, at step #3, and generates a “verify device” response with a unique ID (“installCode” or verification code) to uniquely identify the verification transaction at step #4. The AGE server 30 generates a MT SMS message to be sent to the mobile device 20, via the communication network 40. The SMS message contains an instruction and verification link for the user to click through verification at step #5.

For example, if the phone number of the mobile device is (301) 234-5598, the AGE managed 10-digit phone number is (302) 517-5040, and the verification code is “8emA5gCW”, the SMS message can be represented as follows:

From: (302) 517-5040
To: (301) 234-5598
Please click on
http://xyz.com/8emA5gCV to
complete registration for app XYZ

Upon receipt of the SMS message, the user may be asked to click on the verification link to confirm the verification at step #7. Upon click through, the link is verified by the AGE server 30 at step #8, and is redirected to an URL scheme for the mobile application at step #9. MT Verification is completed when the user is redirected to the URL scheme for the mobile application.

(2) Address Book Capture:

After the mobile owner's phone number is verified, the next task of the social graph creation module 254 at the AGE server 30 is to capture a list of contacts from the user's address book resident on the user's mobile device 20 for purpose of invitation leads generation. The address book is necessary to begin the graphing of social relationships of mobile users.

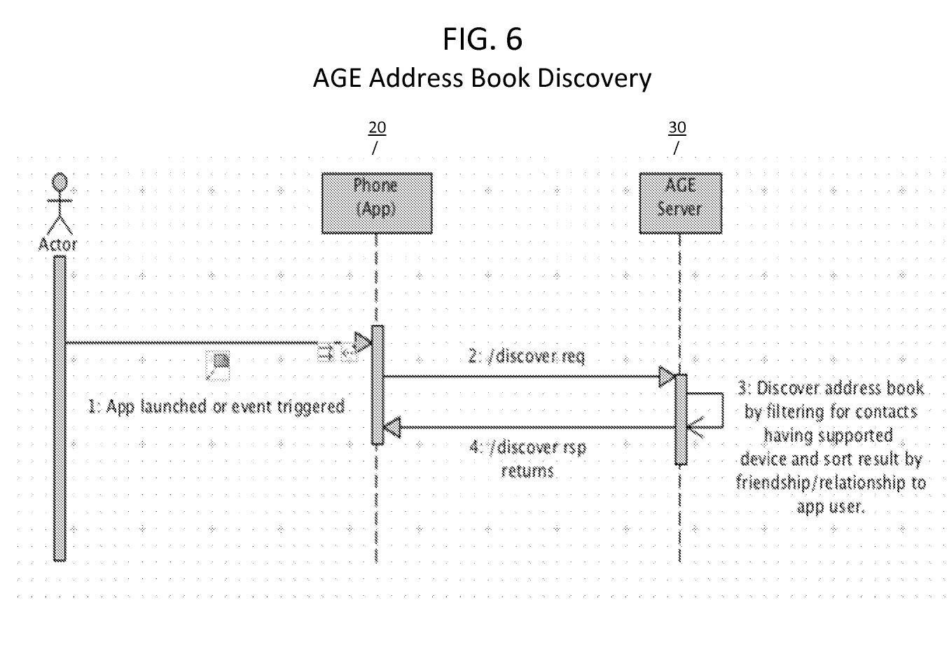

FIG. 6 illustrates an AGE address book discovery sequence diagram between a mobile device 20 and an AGE server 30 according to an example embodiment of the invention. As shown in FIG. 6, when a host application 22 is launched, or when a predetermined event is triggered, such as, for example, every X days or every Y uses, as selected by an application developer at step #1, the host application 22 at the mobile device 20 may invoke an API call for address book discovery and issue a discovery request (/discover req) to the AGE server 30 at step #2. In particular, the host application 22 calls the AGE module 24 at the mobile device 20 for an address book discovery function. The user is prompted to allow access to the address book of the mobile device 20.

Once the user permits such access, all contacts from the address book resident on the mobile device 20 are included in the discovery request (/discover req) and uploaded to the AGE server 30 along with a unique ID (“installCode” or verification code assigned to each app install by AGE server 30) for discovery of address book contacts for qualified contacts.

One benefit for the user to permit such access to contacts from the address book is for the user to know whom in the contacts already have the mobile game s/he is interested to play, and who might be available to play at any given time; otherwise, it could be very frustrating to play a mobile social game, without being able to find other players that already know each other, or play with players with similar skill levels, for example.

Upon receipt of such an API call for address book discovery, the AGE server 30 (by way of the social graph creation module 254, shown in FIG. 3) processes the discovery for each contact in the address book for qualified contacts by filtering for contacts, for example, having the mobile device, carrier network and operating system that support the mobile application or mobile game at step #3 before returning a discovery response (/discover rsp) back to the mobile device 20 at step #4.

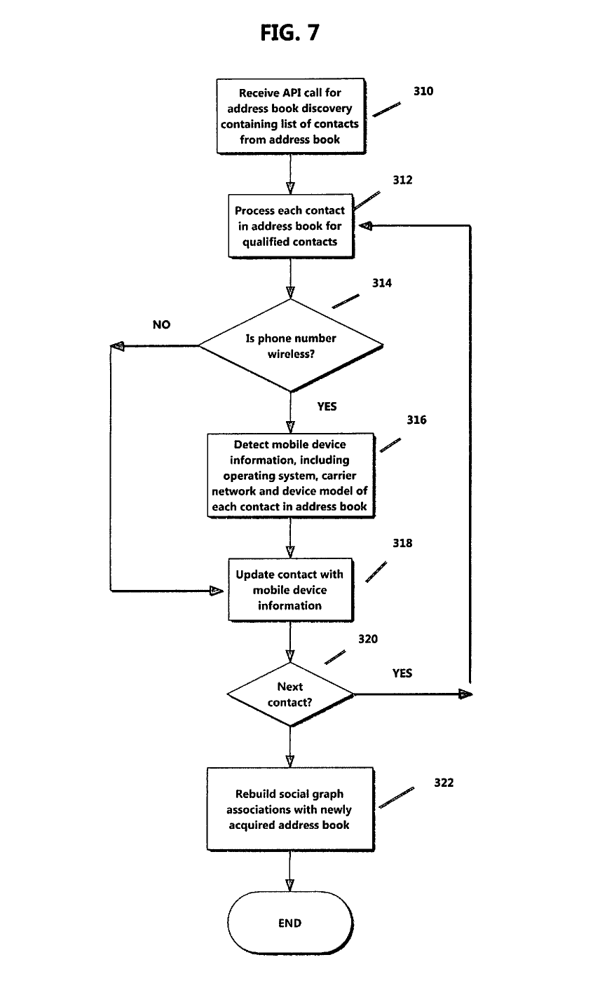

Turning now to FIG. 7, an address book discovery flowchart performed by an AGE server 30 according to an example embodiment of the invention is illustrated. As shown in FIG. 7, the AGE server 30 (by way of the social graph creation module 254, shown in FIG. 3) receives an API call for address book discovery containing a list of contacts from an address book resident on the user's mobile device 20 at block 310. The AGE server 30 then processes each contact in the address book for qualified contacts at block 312. First, the AGE server 30 determines if a phone number of each contact is a mobile (wireless) number at block 314. If a phone number of each contact is a mobile (wireless) number, the AGE server 30 detects mobile device information, including a mobile operating system, carrier network and device model of each contact in the address book at block 316 and then updates such a contact with the mobile device information at block 318. However, if a phone number of each contact is not a mobile (wireless) number, the AGE server 30 updates such a contact with the mobile device information at block 318 and proceeds to process a next contact in the address book at block 320 until all contacts in the address book are processed. The AGE server 30 (by way of the social graph creation module 254, shown in FIG. 3) then rebuilds social graph associations with newly acquired address book for qualified contacts at block 322.

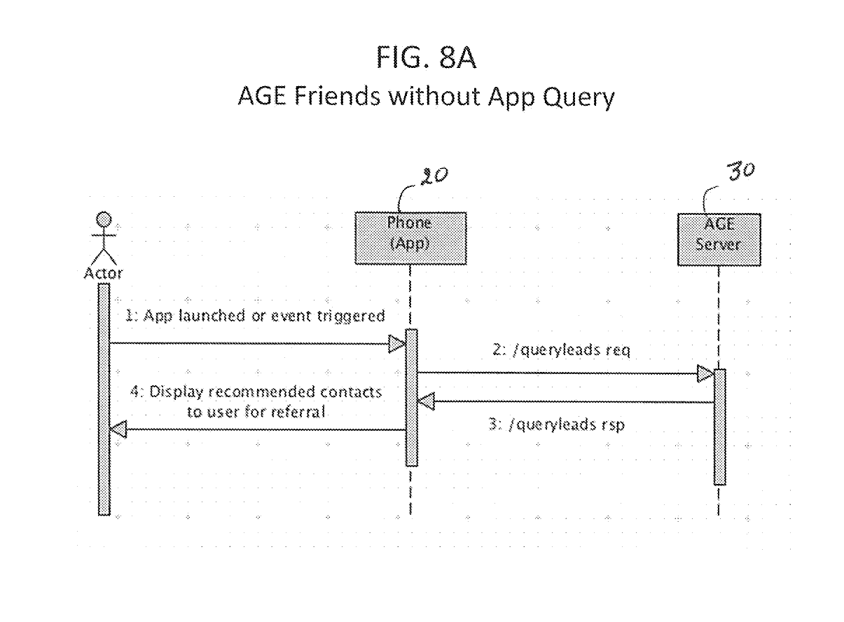

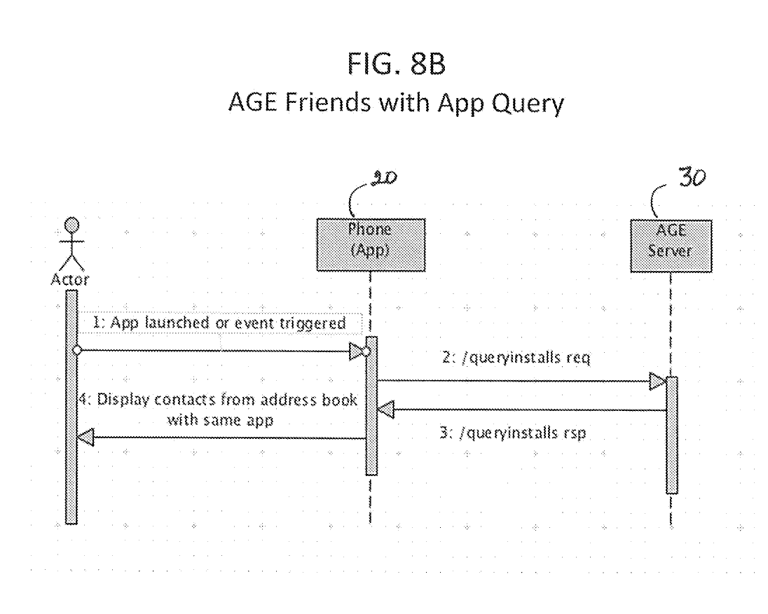

FIGS. 8A-8B illustrate an AGE social invitation sequence diagram with or without an app query between a mobile device 20 and an AGE server 30 according to an example embodiment of the invention. In particular, FIG. 8A illustrates an AGE social invitation sequence diagram without an app query between a mobile device 20 and an AGE server 30. As shown in FIG. 8A, when a host application 22 is launched by the user's mobile device 20, or when a predetermined event is triggered after the address book discovery at step #1, the host application 22 at the mobile device 20 invokes an API call for qualified contacts and issues a lead request (/queryleads req) for previously placed recommended leads, including a unique ID (“installCode” or verification code assigned to each app install by AGE server 30) to the AGE server 30 at step #2.

Upon receipt of such a lead request (/queryleads req), the AGE server 30 (by way of the social graph creation module 254, shown in FIG. 3) returns with a lead response (/queryleads rsp) to the mobile device 20 including a list of qualified or recommended contacts for referral invitations at step #3 for a visual display on the mobile device 20 at step #4.

In contrast to FIG. 8A, FIG. 8B illustrates an AGE social invitation sequence diagram with an app query between a mobile device 20 and an AGE server 30. As shown in FIG. 8B, the host application 22 at the mobile device 20 may invoke an API call for qualified contacts from the address book that have the same app/same installed and issue an install request (/queryinstalls req) for previously placed recommended leads, including a unique ID (“installCode” or verification code assigned to each app install by AGE server 30) to the AGE server 30 at step #2.

Upon receipt of such an install request (/queryinstalls req), the AGE server 30 (by way of the social graph creation module 254, shown in FIG. 3) returns with an install response (/queryinstalls rsp) to the mobile device 20 including a list of contacts that already have the same mobile application or mobile game installed for interactions at step #3 for a visual display on the mobile device 20 at step #4.

(3) Address Book Associations Graphed:

After the address book resident on the user's mobile device 20 is captured, the last task of the social graph creation module 254 at the AGE server 30, shown in FIG. 3, is to form social graph associations and relationships among mobile users and their contacts. The types of relationships determine the weighted score for each contact that will be used in future invitation scenarios. The weighted score will continue to be revised as inputs are added for each contact over the course of the address book discovery process.

The social graph creation module 254 at the AGE server 30 is provided with utilities to detect and derive the user's own phone number assigned by its carrier network, and access the address book resident on the user's mobile device. By comparing the user' phone number and the phone numbers contained in the user's address book, the “social graph” associations, or relational connections between the mobile users, are derived across all users.

There are other methods used to derive the users' “social graph” associations based on user's email or Facebook connect credentials. However, these methods require both parties to provide these credentials in order for the AGE server 30 to form associations. Once the associations are made, the information provides a basis for the AGE server 30 to generate an optimal list of “social invitations” for each perspective user.

The potential relationships for associations include:
i. Mutual Friends: Both mobile owner (A) and contact (B) are in each other's address books;
ii. Shared Friends: Contacts that exist in both mobile owner (A) and contact's (B) address book;
iii. Social Circle: Number of contacts in mobile owner (A) address book that contain contact (B) in their address books; and
iv. Popularity: Number of contacts that have contact (B) in their address book.

(4) Address Book Contacts Analysis:

During the graphing process of the address book, individual contacts and their respective phone numbers are analyzed for associations. The address book discovery process determines the mobile device characteristics for each phone number. The contacts are sorted and filtered as higher priority for future initiation scenarios. The parameters used to determine the sorting and filtering may include, but are not limited to the following:
iv. Is the phone number attached to a mobile device?
v. What is the wireless carrier?
vi. What is the device model?
vii. What is the mobile operating system?

User Profile Development Module 256

Once mobile contact relationships are established, the AGE server 30 begins to apply additional relevant data to further determine a contact's value for invitations. For example, the AGE server 30 may assign a category in game play without having the user to enter any information. The category differentiates mobile users as to their level of interest in downloading and playing certain types of apps/games. The activity profile is calculated by the AGE server 30 based on which games the user downloads or registers his/her mobile device with. This information will be fed into the AGE server 30 (by way of the social graph creation module 254 of the AGE server 30) to optimize “social invitations”.

By reviewing the contact's preferences, future invitations can also be optimized from the accuracy derived from data gathered. The preferences used for the weighted score include but not limited to:
i. Types of mobile applications/games downloaded
ii. How many mobile applications/games have been downloaded?
iii. Where they previously invited from an AGE-enable application?
iv. What is conversion rate of the user from the AGE invitation?

Application Attribute Collection Module 258

The next inputs layered into the AGE server 30 are application attributes and characteristics. The application developer provides the application information during the initial registration and provisioning process. As described in connection with FIG. 4, the application information includes, but not limited to: (i) an application type (game, utility, etc.); (ii) supported mobile platforms such as mobile device and operating system (OS) compatibility for the mobile application (e.g., iOS, Android, Windows Mobile, and BlackBerry RIM); and (iii) wireless network parameters (e.g., AT&T, Verizon Wireless, T-Mobile, and Sprint). In addition, the application attributes include but are not limited to:
i. Application description
ii. Application keywords
iii. Application category

The information provided assists in the scoring of candidates and ranking qualified contacts' relevance to the target applications. The AGE social invitation system leverages technologies developed in-house for mobile messaging, device and network intelligence in order to remotely detect or derive the users' mobile device and network characteristics whose phone numbers are contained in a user's contact list. Specifically, in a co-pending patent application Ser. No. 12/751,267, filed on Mar. 31, 2010 and entitled “System and Method for Broadcasting Rich Media to Devices Over Multiple Carriers”, a content broadcast system is disclosed to provide a variety of content to different mobile devices operating on different carrier networks. For purposes of completeness and to the extent necessary, the subject matter as disclosed by co-pending patent application Ser. No. 12/751,267 is incorporated by reference herein.

For example, if User “A” has User “B” and “C” contained in User A's mobile contact list, the AGE server 30 is able to detect or derive the mobile device 20 and network characteristics of User “B” and User “C”, remotely and without any other information provided by User “B” or User “C”. This makes it possible to pre-qualify User “B” or User “C” as to whether they have a “support device” running on a “supported network”. For example, a mobile game might not be available on Windows Mobile platform, making such devices running on Windows Mobile Platform un-supported. Similarly a mobile game might require a certain access network such as LTE and Wi-Fi. The pre-qualification of user devices and networks derived from user associations is also fed into the AGE server 30 to optimize “social invitations”.

In addition, further data supplied or derived by the device manufacturers or network operators, such as demographic information related to age, gender or income level could also be utilized to enhance the quality and usefulness of such “pre-qualification” criteria.

User Behavior Data Gathering Module 260

Historical data of past invitations are further added to the mobile user's “social graph” to determine contact candidates. The information of which contacts have been previously been invited and successfully downloaded apps/games are applied to the contact candidate's value for future invitations. The user behavioral analytics are collected to calculate the effectiveness of these “social invitations” in a closed loop environment.

Such behavioral analytics may include: (1) the number of users presented a set of social invitations; (2) which of these users actually requested invitations to be sent to their “social graph” associations; (3) how many users, upon receiving an invitation, clicked on the link presented; (4) how many users proceeded to the download web page from the link and onto downloading the mobile application or mobile game; (5) how many users, upon downloading the mobile application or mobile game, registered their mobile devices and opted-in to share their mobile contact list (address book) with the AGE server 30. Using these behavioral inputs to produce analytics, the AGE server 30 is able to calculate the overall closed loop effectiveness of these “social invitations” to be compared with the effectiveness of their user acquisition methodologies, like push marketing, promotional advertising or affiliate programs.

Social Graph Scoring Module 262

At this point in the process, the user social graph associations and relationships have been identified and each contact from the mobile owner's address book has been assigned a social score. The “social graph” is ready and pending for the host application's requests. The host application can make two independent requests:

1. Request for Invitations

2. Request for Fiends with App

Request for Invitations:

The host application 22 calls the AGE module 24 at the mobile device 20 to request for invitations from the AGE server 30. The request from the host application 22 also contains unique parameters such as mobile device model, mobile operating system, and/or wireless carrier network.

The AGE server 30 will process the request by analyzing the “social graph” and filtering out contacts that do meet the app developer's parameters, remove contacts that already have the mobile application or mobile game and query against the user social graph associations to return a ranked list of contacts by relevance for the invitations. The recommended invitations are then returned to the AGE module 24 to be displayed within the host application 22 on the mobile device 20. Alternatively, the list of contacts for invitations may also come directly from the user (e.g., manual phone number input). Either way the recommended invitations can either be sent from the native SMS composer app at the mobile device 20 (supported by Apple's iOS and Google's Android), or from the AGE managed 10-digit phone number (virtual number) at the AGE server 30. If an invitation is sent from user's native SMS composer app at the mobile device 20, then the SMS received will show message sent from app user's phone number. In contrast, if invitation is sent by the AGE server 30, then SMS received will show AGE managed 10-digit phone number. App developer maintains control over the invitation text, so the invitation message can be personalized to include sender and recipient name.

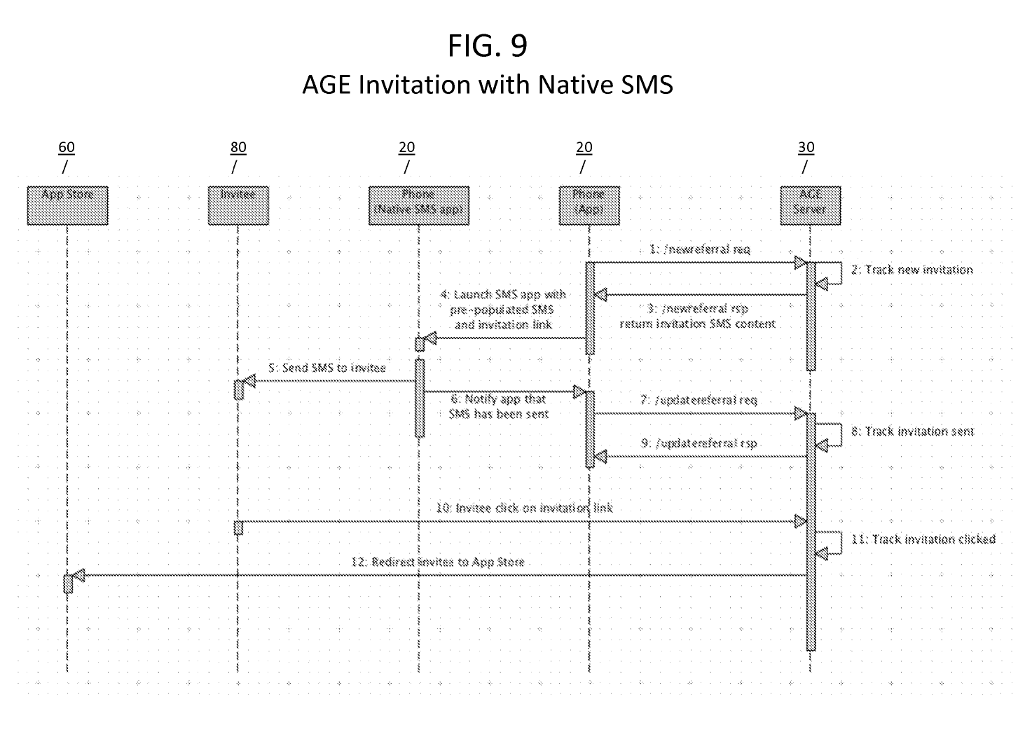

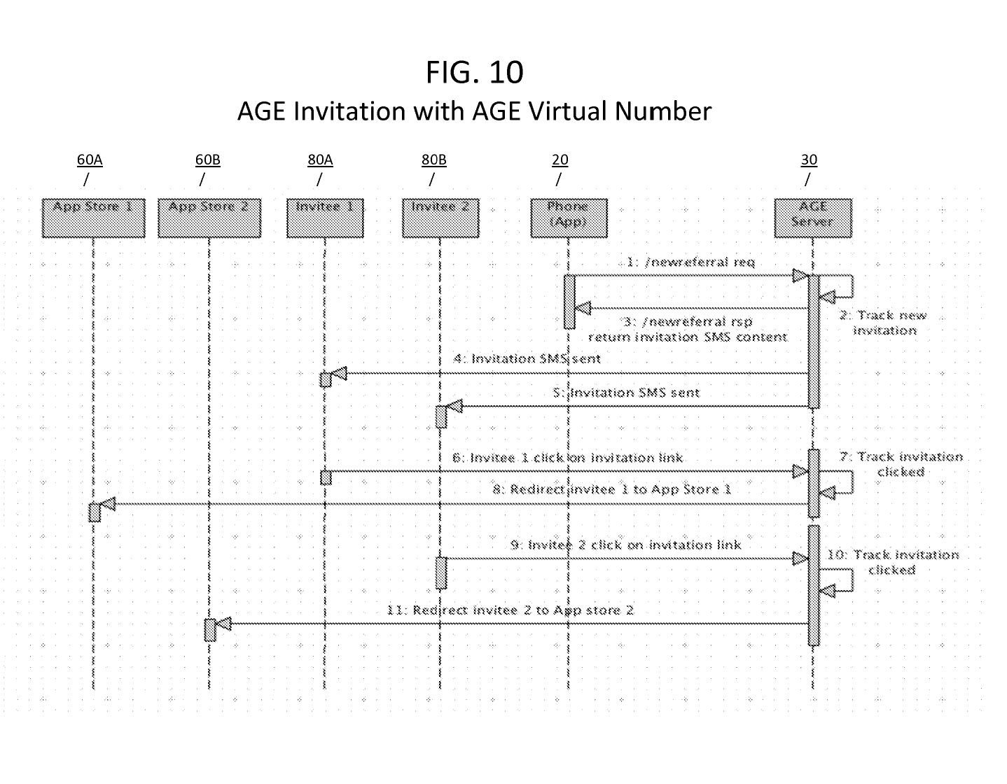

FIG. 9 illustrates an example invitation delivery and tracking for SMS originated from app user's native SMS composer app at the mobile device 20, while FIG. 10 illustrates an example invitation delivery and tracking for SMS originated from AGE managed 10-digit phone number at the AGE server 30. In addition, in various implementations the present invention, FIG. 10 also shows an invitation delivery to multiple invitees, for example, two invitees having different type of mobile device (e.g., iPhone and Android). Referring to FIG. 9, the host application 22 at the mobile device 20 invokes an API call for social invitations and issues a new order for a referral (/newreferral req) containing a unique ID (“installCode” or verification code assigned to each app install by AGE server 30) to the AGE server 30 at step #1. The new order for a referral (/newreferral req) may contain invitation(s) to be sent and tracked for one or more invitees, as shown in FIG. 10.

Upon receipt of such a request (/newreferral req), the AGE server 30 (by way of the social graph creation module 254, shown in FIG. 3) tracks the new invitation at step #2, and returns with a new referral response (/newreferral rsp) to the mobile device 20 including a list of qualified contacts for referral invitations at step #3 for a visual display on the mobile device 20 at step #4. For example, the AGE server 30 may return a list of phone numbers qualified by criteria defined by the app developer. The AGE module 24 at the mobile device 20 looks up the address book resident on the mobile device 20 to identify names of contacts associated with each phone number returned from the AGE server 30.

Next, the native SMS composer app is launched at the mobile device 20 with a pre-populated SMS and invitation link (e.g., customized referral URL) at step #4, and is sent to an invitee 80 with an invitation to download the mobile application or mobile game at step #5. For example, a pre-populated SMS referral message can be represented as follows:

I am playing XYZ game on my
iPhone and would like to play
with you or compare our scores.
Check it out at htttp:/j.mp/KlbIJQ

However, there is a possibility that app user may cancel out of the native SMS composer app and the invitation at step #5. As such, the native SMS composer app notifies the host application 22 at the mobile device 20 that the SMS has been sent at step #6. The host application 22 then informs the AGE server 30 that the invitation was canceled by issuing an update referral request (/updatereferral req) for updating an existing invitation order at step #7. The AGE server 30 (by way of the social graph creation module 254, shown in FIG. 3) tracks the invitation sent at step #8, and returns with an update referral response (/updatereferral rsp) to the mobile device at step #9.

When the invitee clicks on the invitation link (e.g., customized referral URL) at step #10, the AGE server 30 tracks the invitation (referral) clicked by the invitee at step #11 and redirects the invitee to the mobile application provider 60 such as App Store for downloading.

In contrast to FIG. 9, FIG. 10 illustrates an example invitation delivery and tracking for SMS originated from AGE managed 10-digit phone number at the AGE server 30 to multiple invitees, for example, two invitees having different type of mobile device (e.g., iPhone and Android). Referring to FIG. 10, the host application 22 at the mobile device 20 also invokes an API call for social invitations and issues a new order for a referral (/newreferral req) containing a unique ID (“installCode” or verification code assigned to each app install by AGE server 30) to the AGE server 30 at step #1.

Upon receipt of such a request (/newreferral req), the AGE server 30 (by way of the social graph creation module 254, shown in FIG. 3) tracks the new invitation at step #2, and returns with a new referral response (/newreferral rsp) to the mobile device 20 including a list of qualified contacts for referral invitations at step #3. In addition, the AGE server 30 also sends a pre-populated SMS and invitation link (i.e., customized referral URL) to two invitees having different type of mobile device (e.g., iPhone and Android) with an invitation to download the mobile application or mobile game, invitee #1 80A and invitee #2 80B at step #4 and step #5.

When invitee #1 80A or invitee #2 80B clicks on the invitation link (i.e., customized referral URL) at step #6 or step #9, the AGE server 30 tracks the invitation (referral) clicked by the invitee at step #7 or step #10 and redirects the invitee #1 or #2 to the mobile application provider 60A-60B such as App Store for downloading.

Request for Friends with App:

Similarly, the host application 22 calls the AGE module 24 at the mobile device 20 to request for friends with the same app from the AGE server 30. The request from the host application 22 also contains unique parameters such as mobile device model, mobile operating system, and/or wireless carrier network.

The AGE server 30 will process the request by analyzing the “social graph” to determine which contacts already have the same app/game installed, and return a list of friends with the same app/game, i.e., a list of phone numbers from the address book who have the same app/game installed. The recommended invitations are then returned to the AGE module 24 to be displayed within the host application 22 on the mobile device 20 for user selection. Invitation may be sent to each individual contact or friend to join the user in play.

In addition, other search criteria for type of relationship between the mobile user and contacts or friends who have the same app/game installed can also be defined as follow.
FORWARD: Find contacts within the user's address book that have the same app/game.
BACKWARD: Find other app/game users who have the user's phone number in their address book.
MUTUAL: Find contacts within the user's address book who have the same app/game and who also have the user's contact in his/her address book. This query may be useful for engaging a friend to play in multi-player game who already plays the game.

Invitation Conversion Module 264

In order to complete the invitation delivery process, each invitation is tracked to determine its current state. When each invitation is created and sent to an invitee, a pre-populated SMS message is generated either from the mobile device 20 (by way of a native SMS composer app) or from the AGE server 30 to contain a unique URL for tracking. As the invitee receiving the invitation, by clicking on this unique URL the AGE server 30 can track each step of the invitation delivery process. The conversion data for each invitation is recorded in the AGE server 30 for future invitations and displayed on an app developer's dashboard so as to allow the app developer to analyze, target and acquire new users and grow market share, via social invitations, in order to reduce new user acquisition costs.

As described in the foregoing, the present invention advantageously provides an AGE social invitation system including one or more mobile devices in communication with a remote AGE server, via a communication network. Each mobile device is provided with an AGE module in a form of a software development kit (SDK) integrated into a mobile application or mobile game to enable current users to invite and play with friends, family, and colleagues from their mobile contact lists (address books) without ever logging into a 3^{rd} party social networking site, while also enabling mobile application or mobile game developers (1) to increase engagement among current users, (2) to leverage existing users and their contacts information in order to promote their mobile application or game in their users' personal networks, and (3) to analyze, target and acquire new users and grow market share, via social invitations, in order to reduce new user acquisition costs. The remote AGE server is provided with an AGE algorithm to create social graph associations based on address book contacts captured from an address book resident on the mobile device, and in response to a request for social invitations from the mobile device, to generate a list of recommended invitations of target users based on user social graph associations in order to facilitate sharing of the mobile application or mobile game on the user's mobile device. As such, the AGE social invitation system advantageously enhances end users' overall experience by enabling mobile applications or games to be played with and among other players in an easy, seamless, friendly and efficient way.

In order to further illustrate how a currently available mobile game provides “social network” features without integrating with the subject invention as described above in connection with FIGS. 1-10, a popular mobile game, known as “Draw Something”, is used to show how the invention works differently with current practices (prior art). “Draw Something” has been the most popular and fastest growing mobile game this year (Y2012) having reached over 35 million downloads within 6 weeks of release and reaching over 13 million Daily Active Users. People play the game with friends by “Drawing Something” on the mobile application (game) and having their friends guess the drawing, similar to a board game called “Pictionary”. The game is a multiplayer that provides virtually no entertainment value unless a second person joins the game.

As the user downloads the game from an Appstore, the game has no knowledge of the user's social graph (associations). Upon playing the game, the user is presented with two options: either (1) to create an account or (2) to login with their Facebook account. If the user chooses to log into Facebook, the game will be able to identify the user and their social graph data (friends or associations on Facebook). However, the game developer or publisher still cannot derive a direct association, unless a friend on Facebook has also logged into Facebook. As such, three elements are required to make this direct association:
1. Knowing the identity of User A
2. Knowing User B is a friend of User A
3. Knowing the identity of User B

In the “Draw Something” example, an association is made only if both A and B have logged in to the same 3^{rd} party social networking site, such as Facebook.

In contrast to the currently available mobile game with “social network” features, the social invitation methods and tools according to the present invention seek to leverage the mobile address book and work differently. First of all, there is no “log in” required into any 3^{rd} party social networking site. The identity of User A is derived from the verification process of the user's own mobile device phone number. Second, the “friends list” is captured by accessing the user's contact address book resident on the mobile device. Third, the identity of User B is captured when User B also downloads the game and has their mobile phone number verified. The associations are made without the user ever having to log in to any 3^{rd} party social networking site.

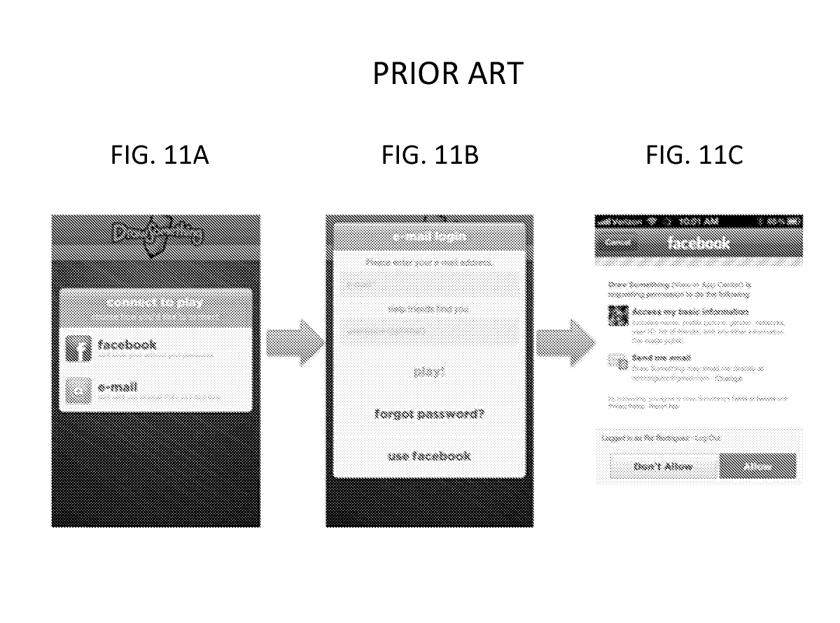

Referring now to FIGS. 11A-11C, the “Draw Something” game is shown along with a known process of creating an account, upon downloading, either by providing an email log-in or Facebook log-in credentials. As shown in FIG. 11A, the user is asked to create an account, either by providing an email log-in, shown in FIG. 11B, or by providing Facebook log-in credentials, shown in FIG. 11C.

Once someone downloads a mobile game, such as “Draw Something”, the first natural question is “who can I play the game with?” In the current implementation of the game, the user can choose among three different sets of people to invite them to play—randomly selected, if the user knows another user's game ID, or a Facebook friend (if the user has logged into Facebook). In the last category of Facebook friends, the friend would receive an invitation message to download the game unless this person has also both downloaded the game AND has logged into Facebook from the game.

Currently these types of “social invitations” while playing mobile games are limited to email or through social networks, as the “Draw Something” experience demonstrates. For the purpose of downloading a mobile game on a mobile device, these invitations messages are not very effective. The person receiving the invitation, either through email or a message from the social network (i.e. Facebook), may or may not be reading the received invitation on a mobile device. If the person receives the invitation on a desktop or laptop computer, for example, by clicking on the URL link that is included within the invitation does not directly lead to the actual installation (download) of the mobile application.

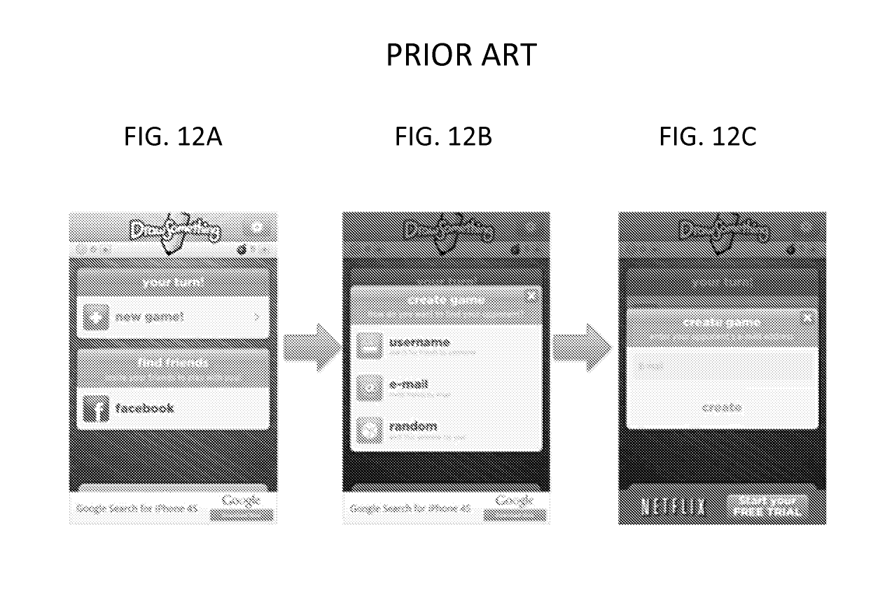

FIGS. 12A-12C show the same “Draw Something” game and the process of initiating a game play, via Game ID username, email, random or Facebook after download. For example, the user is asked to find friends via Facebook, as shown in FIG. 12A, or alternatively, by Game ID Username, Email, or Random, as shown in FIG. 12B and FIG. 12C.

As described in connection with FIGS. 11A-11C and FIGS. 12A-12C, the currently available social invitations are limited to email or through social networks, such as Facebook. However, both of which are less actionable and less effective than methods described in connection with the System for Social Invitations, shown in FIGS. 1-10. Moreover, without any “pre-qualification” of people or friends to be invited to play the mobile game, the current implementations of “social invitations” are unable to neither target nor optimize these invitations to owners of specific mobile devices.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. The concept and AGE social invitation system as described is not limited to social mobile games but are applicable to any mobile application where social connection is desired or necessary. For example, the AGE social invitation system can be utilized in the context of location based mobile applications which enable people to chat. Chat applications may be improved when users who have direct or indirect reference between their address books are discovered, and based on the relationship related information, an app developer can facilitate the sharing among related users and improve the sociability of their application. In addition, a mobile application or mobile game can be implemented using computer readable instructions that are stored on a computer readable medium (e.g., a SIM card, an optical disk (e.g., CD, DVD), a magnetic medium (e.g., a hard-drive, floppy disk), and solid state memory (e.g., RAM, ROM, EEPROM)). The computer readable instructions can be stored in a memory contained in the mobile device, a SIM card, and/or can be downloaded from a computer readable medium and/or from a network connection. Furthermore, various implementations of the invention may be made in hardware, firmware, software-enabled hardware, or any suitable combination thereof. As such, it is intended that the processes described herein be broadly interpreted as being equivalently performed by software, hardware, or a combination thereof. Software modules can be written, via a variety of software languages, including C, C++, Java, Visual Basic, and many others. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Instructions of the software routines or modules may also be loaded or transported into the wireless cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals. Accordingly, it is intended, therefore, that the present invention not be limited to the various example embodiments disclosed, but that the present invention includes all embodiments falling within the scope of the appended claims.

What is claimed is:

1. A method for social invitations to facilitate sharing of a mobile application or game on a mobile device, comprising:
transmitting address book contacts, from an address book resident on a user's mobile device, to an Application Growth Engine (AGE) server for user social graph associations;
sending a request for social invitations to the AGE server;
receiving, from the AGE server, a list of recommended invitations of target users based on the user social graph associations for a visual display on the user's mobile device; and
sending the recommended invitations to the target users to facilitate sharing of the mobile application or game on the user's mobile device.

2. The method as claimed in claim 1, wherein the request for social invitations is sent for one or more target users identified from the address book contacts having the same mobile application or game installed in their mobile devices for playing and interaction on the user's mobile device.

3. The method as claimed in claim 1, wherein the recommended invitations are sent directly either from the user's mobile device, via a short messaging service (SMS), or from the AGE server, via the short messaging service (SMS), based on a request from the user's mobile device.

4. The method as claimed in claim 1, wherein the address book contacts are captured from the address book resident on the user's mobile device and uploaded to the AGE server, via a communication network, when an AGE enabled application is launched on the user's mobile device or when a predetermined event is triggered.

5. The method as claimed in claim 1, wherein the AGE server is configured to verify a phone number of the user's mobile device, and together with the address book on the user's mobile device, to derive associations between users in order to create the user social graph.

6. The method as claimed in claim 5, wherein the AGE server is further configured to:
create social graph associations based on the address book contacts captured from the address book resident on the user's mobile device, user profile and application attributes;
generate a list of recommended invitations of target users optimized based on specific inputs, including: (1) user social graph associations, (2) user and system activity profile gathered from multiple mobile applications or games, (3) pre-qualification of social invitations to targeted users based on the user's mobile device, mobile carrier, and mobile operating system, and (4) relevant behavioral data tracking effectiveness of each social invitation; and
track recommended invitations, including target users who have the same application or game installed in their mobile devices, and to gather user behavioral data to determine the effectiveness of each invitation.

7. A method for social invitations to facilitate sharing of a mobile application or game on an AGE server, comprising:
creating social graph associations based on address book contacts captured from an address book resident on a user's mobile device;
receiving a request for social invitations from the user's mobile device; and
in response to the request for social invitations, generating a list of recommended invitations of target users based on user social graph associations and transmitting the list of recommended invitations to the user's mobile device, for social invitations to the target users to facilitate sharing of the mobile application or game on the user's mobile device.

8. The method as claimed in claim 7, wherein the list of recommended invitations are optimized based on specific inputs, including: (1) user social graph associations; (2) user and system activity profile gathered from multiple mobile applications or games; (3) pre-qualification of social invitations to targeted users based on the user's mobile device, mobile carrier, and mobile operating system; and (4) relevant behavioral data tracking effectiveness of each social invitation.

9. The method as claimed in claim 7, wherein the AGE server is further configured to verify a phone number of the user's mobile device, and together with the address book on the user's mobile device, to derive associations between users in order to create the user social graph.

10. The method as claimed in claim 8, wherein the social graph associations created are further based on a user profile and application attributes, including a supported mobile device, mobile operating system (OS) and carrier network.

11. The method as claimed in claim 7, wherein the AGE server is further configured to track recommended invitations, including target users who have the same application or game installed in their mobile devices, and to gather user behavioral data to determine the effectiveness of each invitation.

12. The method as claimed in claim 7, wherein the mobile device is configured to capture and transmit address book contacts, from the address book resident on the user's mobile device, to the AGE server for user social graph associations, to send the request for social invitations to the AGE server, and to send the recommended invitations to the target users to facilitate sharing of the mobile application or game on the user's mobile device.

13. The method as claimed in claim 7, wherein the request for social invitations is sent for one or more target users identified from the address book contacts having the same mobile application or game installed in their mobile devices for playing and interaction on the user's mobile device.

14. The method as claimed in claim 8, wherein the recommended invitations are sent directly either from the user's mobile device, via a short messaging service (SMS), or from the AGE server, via the short messaging service (SMS), based on a request from the user's mobile device.

15. A mobile device for sending and receiving social invitations to facilitate sharing of a mobile app/game, comprising:
a communication interface arranged to connect the mobile device to a communication network;
a memory to store a mobile app/game; and
a processor system, when the mobile app/game is launched or when a predetermined event is triggered, configured to:
transmit address book contacts, from an address book resident on the mobile device, to a remote AGE server, via the communication network, for user social graph associations;
send a request for social invitations to the remote AGE server, via the communication network;
receive, from the remote AGE server, a list of recommended invitations of target users based on the user social graph associations for a visual display on the mobile device; and
send recommended invitations to the target users to facilitate sharing of the mobile app/game on the mobile device.

16. The mobile device as claimed in claim 15, wherein the request for social invitations is sent for one or more target users identified from the address book contacts having the same mobile app/game installed in their mobile devices for playing and interaction on the mobile device.

17. The mobile device as claimed in claim 15, wherein the recommended invitations are sent directly from either the mobile device, via a short messaging service (SMS), or the remote AGE server, via the short messaging service (SMS), based on a request from the mobile device.

18. The mobile device as claimed in claim 15, wherein the address book contacts are captured from the address book resident on the mobile device and uploaded to the remote AGE server, via the communication network.

19. The mobile device as claimed in claim 15, wherein the remote AGE server is further configured to verify a phone number of the user's mobile device, and together with the address book on the user's mobile device, to derive associations between users in order to create the user social graph.

20. The mobile device as claimed in claim 15, wherein the remote AGE server is further configured to:
create social graph associations based on the address book contacts captured from the address book resident on the mobile device, a user profile and application attributes;
generate a list of recommended invitations of target users optimized based on specific inputs, including: (1) user social graph associations; (2) user and system activity profile gathered from multiple mobile applications or games, (3) pre-qualification of social invitations to targeted users based on the user's mobile device, mobile carrier, and mobile operating system, and (4) relevant behavioral data tracking effectiveness of each social invitation; and
track recommended invitations, including target users who have the same application or game installed in their mobile devices from the address book resident on the mobile device, and to gather user behavioral data to determine the effectiveness of each invitation.

21. An Application Growth Engine (AGE) server for sending and receiving social invitations to facilitate sharing of a mobile app/game, comprising:
a communication interface arranged to connect the AGE server to a communication network; and
a processor system configured to create social graph associations based on address book contacts captured from an address book resident on a user's mobile device, and in response to a request for social invitations from the user's mobile device, generate a list of recommended invitations of target users based on user social graph associations and transmit the list of recommended invitations to the user's mobile device, for social invitations to the target users to facilitate sharing of the mobile app/game on the user's mobile device.

22. The AGE server as claimed in claim 21, wherein the list of recommended invitations are optimized based on specific inputs, including: (1) user social graph associations; (2) a user profile and system activity profile gathered from multiple mobile apps or games; (3) pre-qualification of social invitations to targeted users based on the user's mobile device, mobile carrier, and mobile operating system; and (4) relevant behavioral data tracking effectiveness of each social invitation.

23. The AGE server as claimed in claim 21, wherein the processor system is further configured to verify a phone number of the user's mobile device, and together with the address book on the user's mobile device, to derive associations between users in order to create the user social graph.

24. The AGE server as claimed in claim 21, wherein the processor system is further configured to track recommended invitations, including target users who have the same app/game installed in their mobile devices from the address book resident on the mobile device, and to gather user behavioral data to determine the effectiveness of each invitation.

25. The AGE server as claimed in claim 21, wherein the request for social invitations is sent for one or more target users identified from the address book contacts having the same mobile app/game installed in their mobile devices for playing and interaction on the user's mobile device.

26. The AGE server as claimed in claim 21, wherein the recommended invitations are sent, via a short messaging service (SMS), based on a request from the user's mobile device, or sent directly from the user's mobile device, via the short messaging service (SMS).

27. A computer readable medium having stored thereon a plurality of instructions which, when executed by a processor of a mobile device, cause the processor to perform the method comprising:
transmitting address book contacts, from an address book resident on the mobile device, to a remote AGE server, via a communication network, for user social graph associations;
sending a request for social invitations to the remote AGE server, via the communication network;
receiving, from the remote AGE server, a list of recommended invitations of target users based on the user social graph associations for a visual display on the mobile device; and
sending recommended invitations to the target users to facilitate sharing of the mobile app/game on the mobile device.

28. The computer readable medium as claimed in claim 27, wherein the address book contacts are captured from the address book resident on the user's mobile device and uploaded to the AGE server, via a communication network, when an AGE enabled application is launched on the user's mobile device or when a predetermined event is triggered.

29. The computer readable medium as claimed in claim 27, wherein the list of recommended invitations are optimized based on specific inputs, including: (1) user social graph associations; (2) a user profile and system activity profile gathered from multiple mobile apps or games; (3) pre-qualification of social invitations to targeted users based on the user's mobile device, mobile carrier, and mobile operating system; and (4) relevant behavioral data tracking effectiveness of each social invitation.

30. The computer readable medium as claimed in claim 27, wherein the recommended invitations are sent directly either from the user's mobile device, via a short messaging service (SMS), or from the AGE server, via the short messaging service (SMS), based on a request from the user's mobile device.
